(19) United States
(12) Patent Application Publication
(10) Pub. No.: US 2022/0001757 A1
(43) Pub. Date: Jan. 6, 2022

(54) VEHICLE CONNECTOR

(71) Applicant: SUMITOMO WIRING SYSTEMS, LTD., Yokkaichi-shi, Mie (JP)

(72) Inventor: Yu KITO, Yokkaichi-shi, Mie (JP)

(21) Appl. No.: 17/295,665

(22) PCT Filed: Nov. 8, 2019
(86) PCT No.: PCT/JP2019/043981

§ 371 Date: May 20, 2021

(30) Foreign Application Priority Data
Nov. 28, 2018 (JP) 2018-222174

(51) Int. Cl. B60L 53/16; H01R 13/52; H01R 13/506; H01R 13/74

(52) U.S. Cl. CPC B60L 53/16; H01R 13/5213; H01R 2201/26; H01R 13/748; H01R 13/506

(57) ABSTRACT

A charging inlet includes a tubular portion having a tip side projecting to the outside of a vehicle through a mounting hole of the vehicle, an external connector being fit into an opening on the tip side, an outward extending fixing portion extending outward from a base end side of the tubular portion and to be fixed to the vehicle while being butted against the vehicle in a tip direction of the tubular portion, a rotary shaft arranged on an outer side of the tip side of the tubular portion, and a cover portion provided rotatably about the rotary shaft for opening and closing the opening of the tubular portion. The rotary shaft and the cover portion are provided on a fixing member fixable to the tip side of the tubular portion passed through the mounting hole.

### TECHNICAL FIELD

The present invention relates to a vehicle connector such as a charging inlet.

### BACKGROUND

Some vehicles include a vehicle connector. Particularly, electric vehicles and plug-in hybrid vehicles include a charging inlet as a vehicle connector for connecting an external connector for charging. Some charging inlets include a tubular portion having a tip side projecting out through a mounting hole of a vehicle and having an external connector fit into an opening on the tip side, and an outward extending fixing portion extending outward from a base end side of the tubular portion and to be fixed to the vehicle while being butted against the vehicle in a tip direction of the tubular portion (see, for example, Patent Document 1). This charging inlet includes a pair of support walls bulging outward from the outer periphery of the tip side of the tubular portion, a rotary shaft is supported on the support walls, and a cover portion for opening and closing the opening of the tubular portion is supported on the rotary shaft.

### PRIOR ART DOCUMENT

### Patent Document

Patent Document 1: JP 2018-101547 A

### SUMMARY OF THE INVENTION

### Problems to be Solved

However, in the charging inlet as described above, the mounting hole of the vehicle needs to be so shaped that the support walls can be passed therethrough. Thus, there has been a problem that the mounting hole of the vehicle is enlarged. Note that since the mounting hole of the vehicle is, for example, formed in a bottom part of a recess provided in a body of the vehicle, the enlargement of the mounting hole causes the enlargement of the recess and a lid for opening and closing an opening of the recess.

The present invention was developed to solve the above problem and aims to provide a vehicle connector capable of making a mounting hole of a vehicle smaller.

### Means to Solve the Problem

A vehicle connector for solving the above problem includes a tubular portion having a tip side projecting out through a mounting hole of a vehicle, an external connector being fit into an opening on the tip side of the tubular portion, an outward extending fixing portion extending outward from a base end side of the tubular portion, the outward extending fixing portion being fixed to the vehicle while being butted against the vehicle in a tip direction of the tubular portion, a rotary shaft arranged on an outer side of the tip side of the tubular portion, and a cover portion provided rotatably about the rotary shaft for opening and closing the opening of the tubular portion, the rotary shaft and the cover portion being provided on a fixing member fixable to the tip side of the tubular portion passed through the mounting hole.

According to this configuration, since the rotary shaft and the cover portion are provided on the fixing member fixable to the tip side of the tubular portion passed through the mounting hole of the vehicle, the mounting hole of the vehicle can be made smaller than in a configuration in which the rotary shaft arranged on the outer side of the tip side of the tubular portion is integrally provided to the tubular portion. That is, the mounting hole needs not be formed such that the rotary shaft and the like arranged on the outer side of the tip side of the tubular portion can be passed therethrough, and the mounting hole can be made smaller.

In the above vehicle connector, the fixing member is preferably fittably provided on the tip side of the tubular portion.

According to this configuration, since the fixing member is fittably provided on the tip side of the tubular portion, a fixing operation is easier than, for example, when the fixing member is screwed.

In the above vehicle connector, the fixing member is preferably detachably provided on the tip side of the tubular portion.

According to this configuration, since the fixing member is detachably provided on the tip side of the tubular portion, an exchange of the cover portion is easy, for example, when the cover portion is broken.

In the above vehicle connector, the fixing member is preferably formed into an annular shape externally fittable to the tubular portion.

According to this configuration, since the fixing member is formed into an annular shape externally fittable to the tubular portion, the fixing member can be firmly fixed to the tubular portion as compared to the case where the fixing member is formed into a non-annular shape. That is, if the fixing member is formed into an annular shape and externally fit to the tubular portion, the inner periphery of the fixing member is supported on the outer periphery of the tubular portion even if a force is applied to the fixing member in any direction other than an axial direction. Thus, the fixing member can be firmly fixed to the tubular portion.

In the above vehicle connector, the fixing member is preferably provided with a locked portion lockable by a locking portion provided on the cover portion in a closing state of the cover portion.

According to this configuration, since the fixing member is provided with the locked portion lockable by the locking portion provided on the cover portion in the closing state of the cover portion, the mounting hole can be made smaller than, for example, in a configuration in which the locked portion is integrally provided to the tubular portion on an outer side of the tip side of the tubular portion. That is, the mounting hole needs not be formed such that the locked portion arranged on the outer side of the tip side of the tubular portion can be passed therethrough, and the mounting hole can be made smaller.

In the above vehicle connector, the locked portion is preferably a locking shaft as a common component to the rotary shaft.

According to this configuration, since the locked portion is the locking shaft as a common component to the rotary shaft, which of those common components should be used as the rotary shaft can be selected. Thus, an opening direction of the cover portion can be easily changed according to a specification or the like, and vehicles and the like having different specifications can be easily dealt with.

### Effect of the Invention

According to the vehicle connector of the present invention, the mounting hole of the vehicle can be made smaller.

### BRIEF DESCRIPTION OF THE DRAWINGS

FIG. 1 is a top view showing a state where a charging inlet of one embodiment is mounted on a vehicle.

FIG. 2 is a top view showing a state before the charging inlet of the one embodiment is mounted on the vehicle.

FIG. 3 is a perspective view of the charging inlet of the one embodiment.

FIG. 4 is an exploded perspective view of the charging inlet of the one embodiment.

FIG. 5 is a front view of the charging inlet of the one embodiment.

FIG. 6 is a section along 6-6 in FIG. 5.

### DETAILED DESCRIPTION TO EXECUTE THE INVENTION

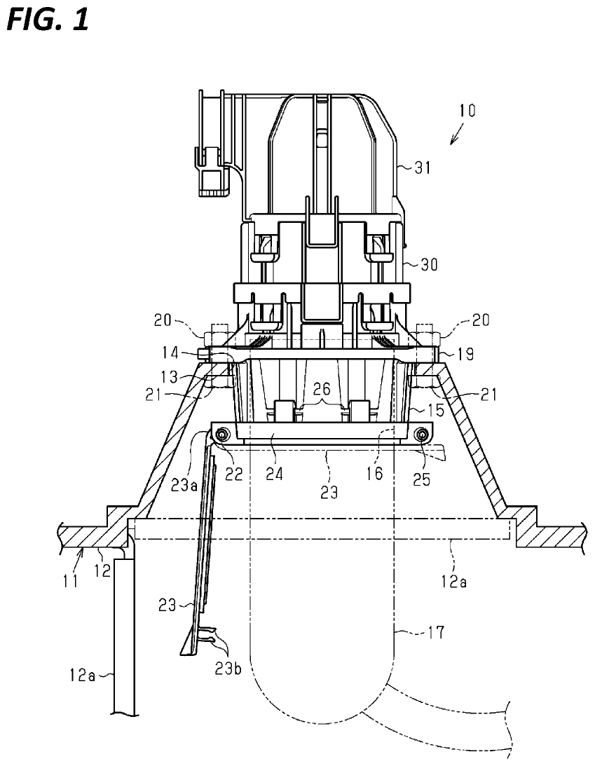

Hereinafter, one embodiment of a charging inlet serving as a vehicle connector is described with reference to FIGS. 1 to 6. Note that, in each figure, some components may be shown in an exaggerated or simplified manner for the sake of description. Further, a dimensional ratio of each component may be different from an actual one.

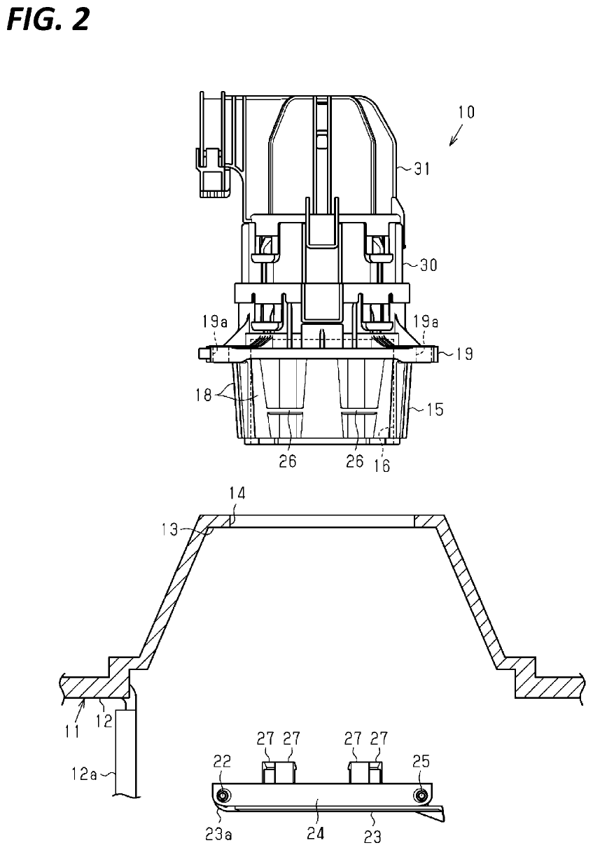

As shown in FIGS. 1 and 2, a recess 13 is provided in an outer surface of a body 12 of a vehicle 11 to which a charging inlet 10 is to be fixed. A mounting hole 14 is provided in a bottom part of the recess 13. Further, the vehicle 11 is provided with a lid 12a capable of opening and closing an opening of the recess 13.

The charging inlet 10 includes a tubular portion 15 having a tip side projecting out through the mounting hole 14. The tubular portion 15 is so formed that an external connector 17 (see FIG. 1) is fittable into an opening 16 on the tip side thereof.

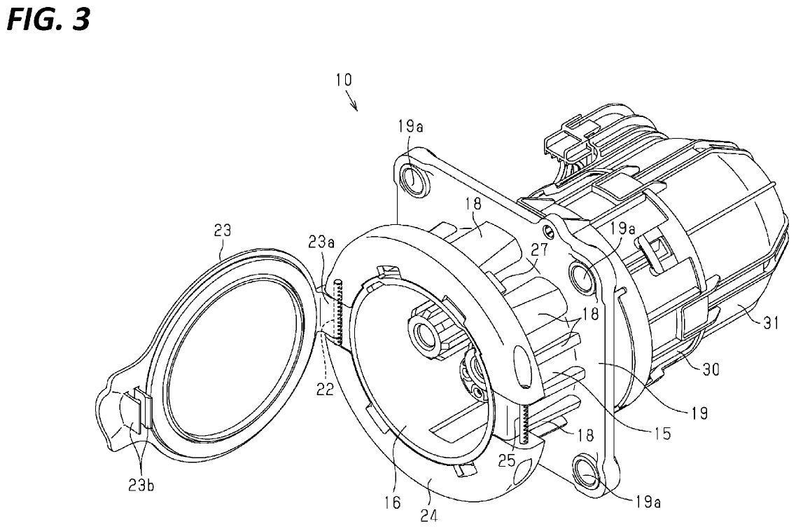

As shown in FIGS. 3 to 5, the tubular portion 15 of this embodiment is formed into a substantially hollow cylindrical shape. Further, a plurality of axial ribs 18 extending in an axial direction are formed in a circumferential direction on the outer peripheral surface of the tubular portion 15.

Further, the charging inlet 10 includes an outward extending fixing portion 19 extending outward from a base end side of the tubular portion 15. The outward extending fixing portion 19 of this embodiment is formed into a substantially rectangular shape when viewed from the axial direction of the tubular portion 15, and fixing holes 19 are respectively formed near four corners of the outward extending fixing portion 19. The outward extending fixing portion 19 is butted against the bottom part of the recess 13 in the vehicle 11 in a tip direction (downward direction in FIG. 1). The outward extending fixing portion 19 is fixed to the bottom part of the recess 13 by bolts 21 passed through unillustrated holes formed in the bottom part of the recess 13 and the fixing holes 19a and threadably engaged with nuts 20.

Further, the charging inlet 10 includes a rotary shaft 22 arranged on an outer side of the tip side of the tubular portion 15 and a cover portion 23 provided rotatably about the rotary shaft 22 for opening and closing the opening 16 of the tubular portion 15.

The rotary shaft 22 and the cover portion 23 are provided on a fixing member 24 fixable to the tip side of the tubular portion 15 passed through the mounting hole 14.

Specifically, the fixing member 24 is formed into an annular shape externally fittable to a tip part of the tubular portion 15. The rotary shaft 22 extending in a direction along a tangent to the inner periphery of the fixing member 24 is fixed to a circumferential part of the fixing member 24. Further, a locking shaft 25 serving as a locked portion extending in a direction along a tangent to the inner periphery of the fixing member 24 is fixed to a circumferential part of the fixing member 24. The locking shaft 25 is provided at a position facing the rotary shaft 22 in the fixing member 24. In particular, the locking shaft 25 is provided at a position separated from the rotary shaft 22 by 180° in the fixing member 24. Further, the rotary shaft 22 and the locking shaft 25 are formed by common components. In particular, the rotary shaft 22 and the locking shaft 25 of this embodiment are formed by metal pins having the same product number. The common components may normally indicate interchangeably usable components having the same shape and the same dimensions and made of the same material.

The cover portion 23 is formed into a substantially disk shape. A support portion 23a to be rotatably supported on the rotary shaft 22 is provided on a part of the outer edge of the cover portion 23. Further, a locking portion 23b lockable to the locking shaft 25 in a closing state of the cover portion 23 to close the opening 16 of the tubular portion 15 is provided on a part of the outer edge of the cover portion 23. Note that the locking portion 23b of this embodiment is composed of a pair of holding pieces capable of holding the locking shaft 25 therebetween.

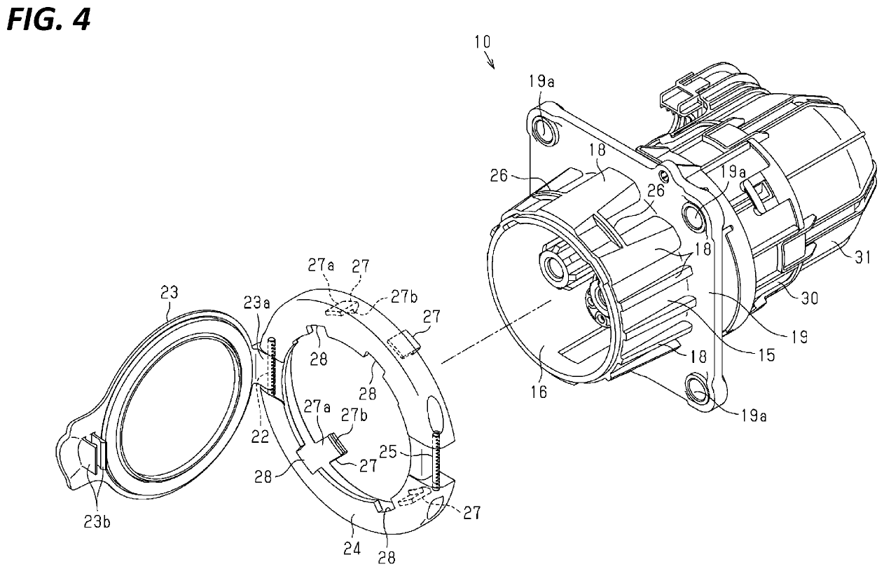

Further, the fixing member 24 is detachably provided on the tip side of the tubular portion 15. In particular, as shown in FIG. 4, a plurality of locking ribs 26 extending along the circumferential direction are formed along the circumferential direction on the outer peripheral surface of the tubular portion 15. The locking ribs 26 of this embodiment are formed between adjacent ones of the axial ribs 18 to couple those axial ribs 18. Further, four locking ribs 26 are provided in the circumferential direction. In particular, in the circumferential direction of the tubular portion 15, two locking ribs 26 are arranged in each circumferential interval between a circumferential position where the rotary shaft 22 is arranged and a circumferential position where the locking shaft 25 is arranged. Further, the locking ribs 26 are arranged at intermediate positions between the rotary shaft 22 and the locking shaft 25 and line-symmetrical with respect to a center line extending in parallel to the rotary shaft 22 and the locking shaft 25 when viewed from the axial direction of the tubular portion 15.

The fixing member 24 is provided with locking claws 27 attachable to and detachable from the locking ribs 26. The locking claws 27 are provided at positions corresponding to the respective locking ribs 26. As shown in FIGS. 4 to 6, inner edge recesses 28 recessed radially outward are formed in parts of the inner edge of the fixing member 24. As shown in FIGS. 4 to 6, the locking claw 27 includes an axial piece 27a extending in the axial direction from the inner edge recess 28 of the fixing member 24 and a claw 27b projecting radially inward from a tip part of the axial piece 27a. The axial piece 27a is formed outwardly of the locking rib 26 in a radial direction of the tubular portion 15. The claw 27b is formed at the same position as the locking rib 26 in the radial direction of the tubular portion 15. Thus, as shown in FIG. 6, the fixing member 24 can be fit and fixed to the tubular portion 15 by relatively moving the fixing member 24 in the axial direction with respect to the tubular portion 15 and hooking the claws 27b of the locking claws 27 to the locking ribs 26. Further, the fixing member 24 can be detached from the tubular portion 15 by inserting a tool such as a screw driver from the inner edge recesses 28 and disengaging the claws 27b from the locking ribs 26 by resiliently deforming the axial pieces 27a radially outward by the tool.

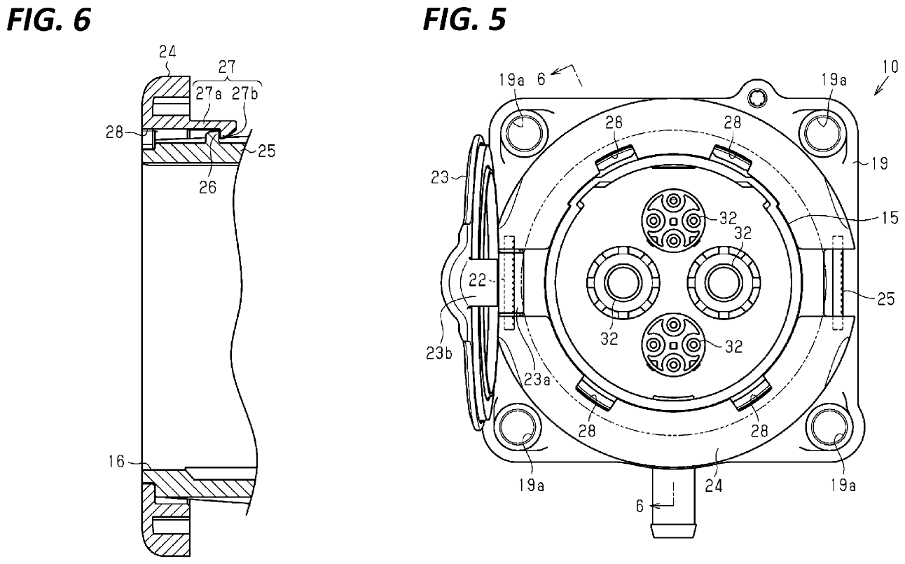

Further, as shown in FIGS. 1 to 4, the charging inlet 10 includes a housing 30 to be fit to a base end part of the tubular portion 15 and an end housing 31 to be fit to the housing 30. A plurality of terminals 32 (see FIG. 5) to be electrically connected to terminals of the external connector 17 (see FIG. 1) to be fit into the opening 16 are provided inside the tubular portion 15. The terminals 32 are electrically connected to a battery via unillustrated wiring and electrical device passed through the housing 30 and the end housing 31.

Next, a mounting method and functions of the charging inlet 10 configured as described above are described.

As shown in FIG. 2, the tubular portion 15, to which the fixing member 24 is not fixed, is passed through the mounting hole 14 from the inside of the vehicle 11 to cause the tip side of the tubular portion 15 to project out. Then, as shown in FIG. 1, the outward extending fixing portion 19 is butted against the bottom part of the recess 13 in the tip direction (downward direction in FIG. 1) of the tubular portion 15. Then, the outward extending fixing portion 19 is fixed to the bottom part of the recess 13 by the bolts 21 passed through the unillustrated holes formed in the bottom part of the recess 13 and the fixing holes 19a of the outward extending fixing portion 19 and the nuts 20. Then, the fixing member 24 is fixed to the tip side of the tubular portion 15, whereby the mounting of the charging inlet 10 is completed.

Next, functions of this embodiment are described below.

(1) The rotary shaft 22 and the cover portion 23 are provided on the fixing member 24 fixable to the tip side of the tubular portion 15 passed through the mounting hole 14 of the vehicle 11. Thus, the mounting hole 14 can be made smaller than in a configuration in which the rotary shaft 22 arranged on the outer side of the tip side of the tubular portion 15 is integrally provided to the tubular portion 15. That is, the mounting hole 14 needs not be formed such that the rotary shaft 22 arranged on the outer side of the tip side of the tubular portion 15 and the like can be passed therethrough, and the mounting hole 14 can be made smaller. As a result, in this embodiment, the recess 13 and the lid 12a for opening and closing the opening of the recess 13 can be made smaller.

(2) Since the fixing member 24 is fittably provided on the tip side of the tubular portion 15, a fixing operation is easier than, for example, when the fixing member 24 is screwed.

(3) Since the fixing member 24 is detachably provided on the tip side of the tubular portion 15, an exchange of the cover portion 23 is easy, for example, when the cover portion 23 is broken.

(4) Since the fixing member 24 is formed into an annular shape externally fittable to the tubular portion 15, the fixing member 24 can be firmly fixed to the tubular portion 15 as compared to the case where the fixing member 24 is formed into a non-annular shape. That is, if the fixing member 24 is formed into an annular shape and externally fit to the tubular portion 15, the inner periphery of the fixing member 24 is supported on the outer periphery of the tubular portion 15 even if a force is applied to the fixing member 24 in any direction other than the axial direction. Thus, the fixing member 24 can be firmly fixed to the tubular portion 15.

(5) Since the fixing member 24 is provided with the locking shaft 25 lockable by the locking portion 23b provided on the cover portion 23 in the closing state of the cover portion 23, the mounting hole 14 can be made smaller than, for example, in a configuration in which the locking shaft 25 is integrally provided to the tubular portion 15 on an outer side of the tip side of the tubular portion 15. That is, the mounting hole 14 needs not be formed such that the locking shaft 25 arranged on the outer side of the tip side of the tubular portion 15 can be passed therethrough, and the mounting hole 14 can be made smaller.

(6) Since the locking shaft 25 is a common component to the rotary shaft 22, which of those common components should be used as the rotary shaft 22 can be selected. Thus, an opening direction of the cover portion 23 can be easily changed, and vehicles 11 and the like having different specifications can be easily dealt with.

This embodiment can be modified and carried out as follows. This embodiment and the following modifications can be combined without technically contradicting each other.
Although the fixing member 24 is fittably provided on the tip side of the tubular portion 15 in the above embodiment, there is no limitation to this and the fixing member 24 may be fixed to the tip side of the tubular portion 15, for example, by screws or the like. Further, although the fixing member 24 is fittable to the tip side of the tubular portion 15 by the locking ribs 26 and the locking claws 27 in the above embodiment, the fixing member 24 may be made fittable by another configuration.
Although the fixing member 24 is detachably fittable on the tip side of the tubular portion 15 in the above embodiment, there is no limitation to this and the fixing member 24 may be fixed to the tip side of the tubular portion 15, for example, by screws, an adhesive or the like. Further, although the fixing member 24 is fittable to the tip side of the tubular portion 15 by the locking ribs 26 and the locking claws 27 in the above embodiment, the fixing member 24 may be made fittable by another configuration.
Although the fixing member 24 is formed into an annular shape externally fittable to the tubular portion 15 in the above embodiment, the fixing member 24 may have another shape if the rotary shaft 22 can be firmly supported.
Although the fixing member 24 is provided with the locking shaft 25 serving as the locked portion lockable by the locking portion 23b provided on the cover portion 23 in the closing state of the cover portion 23 in the above embodiment, there is no limitation to this and the locked portion may be integrally provided to the tubular portion 15.
Although the locking shaft 25 is a common component to the rotary shaft 22 in the above embodiment, there is no limitation to this and the locking shaft 25 and the rotary shaft 22 may be components having different product numbers. Of course, the locking shaft 25 can be formed into a locked portion having another shape and the locking portion 23b of the cover portion 23 may have another shape.
Although four locking ribs 26 are provided on the outer peripheral surface of the tubular portion 15 in the above embodiment, there is no limitation to this and three or less or five or more locking ribs 26 may be provided.
Although the present invention is embodied as the charging inlet 10 in the above embodiment, the present invention may be embodied as another vehicle connector.
In the shown embodiment, the housing 30, the end housing 31 and the outward extending fixing portion 19, out of the charging inlet 10, are typical examples of inner components to be arranged inside the body 12.
In the shown embodiment, the tubular portion 15, the rotary shaft 22, the cover portion 23, the fixing member 24 and the locking shaft 25, out of the charging inlet 10, are typical examples of outer components to be arranged outside the body 12.
In the shown embodiment, the outward extending fixing portion 19 is a typical example of a positioning stopper having a positioning surface configured to contact and/or be fixed to the inner surface of the body 12. The outward extending fixing portion 19 can have a first maximum outer diameter larger than a maximum inner diameter of the mounting hole 14 so that the outward extending fixing portion 19 cannot pass through the mounting hole 14. Here, if the mounting hole 14 is a circular hole, an inner diameter thereof is the maximum inner diameter of the mounting hole 14. If the mounting hole 14 is a non-circular hole such as an oval hole, an elliptical hole or a polygonal hole, a major axis or a longest diagonal distance of the mounting hole 14 is the maximum inner diameter of the mounting hole 14. If the outward extending fixing portion 19 has a circular contour when viewed in an axial direction of the charging inlet 10, a diameter of the outward extending fixing portion 19 is the first maximum outer diameter. If the outward extending fixing portion 19 has a non-circular contour such as an oval contour, an elliptical contour or a polygonal contour, a major axis or a longest diagonal distance of the outward extending fixing portion 19 is the first maximum outer diameter.
In the shown embodiment, the tubular portion 15 is a typical example of a tubular socket having a second maximum outer diameter equal to or smaller than the maximum inner diameter of the mounting hole 14.
In the shown embodiment, the fixing member 24 and the tubular portion 15 are separate components and the fixing member 24 can be configured to be fit on the annular tip part of the tubular portion 15 later. For example, the fixing member 24 can have a third maximum outer diameter larger than the maximum inner diameter of the mounting hole 14, and can have a mounting surface configured to contact and/or be fixed to a part of or the entirety of the outer peripheral surface of the annular tip part of the tubular portion 15.
The cover portion 23 of the shown embodiment may be configured as a waterproof cap for reducing or preventing the entrance of a liquid such as rain into the opening 16 from the outside of the tubular portion 15.

The present disclosure includes the following implementation examples. Constituent elements of the implementation examples are denoted by reference signs of constituent elements of the embodiment not for limitation, but for understanding assistance.

[Addendum 1] One or more of the implementation examples of the present invention are directed to a charging inlet (10) configured to be fixed to a vehicle body (12) including a through hole (14) penetrating from an outer surface to an inner surface. The charging inlet (10) can include inner components (30, 31, 19) to be arranged inside the vehicle body (12) and outer components (15, 22, 23, 24, 25) to be arranged outside the vehicle body (12),

the inner components (30, 31, 19) of the charging inlet (10) can include a positioning stopper (19) having a positioning surface configured to contact and/or be fixed to the inner surface of the vehicle body (12) and the positioning stopper (19) can have a first maximum outer diameter larger than a maximum inner diameter of the through hole (14) so that the positioning stopper (19) cannot pass through the through hole (14),

the outer components (15, 22, 23, 24, 25) of the charging inlet (10) can include a tubular socket (15) projecting outwardly of the vehicle body (12) through the through hole (14) with the positioning surface of the positioning stopper (19) held in contact with and/or fixed to the inner surface of the vehicle body (12) and the tubular socket (15) can have a second maximum outer diameter equal to or smaller than the maximum inner diameter of the through hole (14),

the tubular socket (15) can include an annular tip part having a tip opening (16) allowing an access of an external connector (17) to a plurality of terminals (32), which may include a charging terminal and/or a charging control terminal, and the outer components (15, 22, 23, 24, 25) of the charging inlet (10) can include a fixing member (24) as a component separate from the tubular socket (15), and the fixing member (24) can have a third maximum outer diameter larger than the maximum inner diameter of the through hole (14) so that the fixing member (24) cannot pass through the through hole (14).

[Addendum 2] The fixing member (24) can have a mounting surface configured to contact and/or be fixed to a part of or the entirety of an outer peripheral surface of the annular tip part of the tubular socket (15).

[Addendum 3] The fixing member (24) can be configured to be fit on the annular tip part of the tubular socket (15) later with the tubular socket (15) passed through the through hole (14) and projecting outwardly of the vehicle body (12).

[Addendum 4] The fixing member (24) can be configured to support a waterproof cap (23) configured to close the tip opening (16) of the tubular socket (15).

[Addendum 5] The fixing member (24) can include a hinge shaft (22), and the hinge shaft (22) can rotatably support the waterproof cap (23) such that the waterproof cap (23) moves between a closing position for closing the tip opening (16) of the tubular socket (15) and an opening position for opening the tip opening (16).

[Addendum 6] The positioning stopper (19) included in the inner components (30, 31, 19) and the tubular socket (15) included in the outer components (15, 22, 23, 24, 25) can be configured as mutually different parts of a one-piece article.

[Addendum 7] The positioning stopper (19) can be configured as a flange. It would be apparent to a person skilled in the art that the present invention may be embodied in another specific form without departing from the technical concept thereof. For example, some of the components described in the embodiment (or one or more modes thereof) may be omitted or several of the components may be combined. The scope of the present invention should be determined together with the full scope of equivalents for which a right is granted by claims with reference to the appended claims.

### LIST OF REFERENCE NUMERALS

10 . . . charging inlet (vehicle connector)
11 . . . vehicle
14 . . . mounting hole
15 . . . tubular portion
16 . . . opening
17 . . . external connector
19 . . . outward extending fixing portion
22 . . . rotary shaft
23 . . . cover portion
23b . . . locking portion
24 . . . fixing member
25 . . . locking shaft (locked portion)

1. A vehicle connector, comprising:
a tubular portion having a tip side projecting out through a mounting hole of a vehicle, an external connector being fit into an opening on the tip side of the tubular portion;
an outward extending fixing portion extending outward from a base end side of the tubular portion, the outward extending fixing portion being fixed to the vehicle while being butted against the vehicle in a tip direction of the tubular portion;
a rotary shaft arranged on an outer side of the tip side of the tubular portion; and
a cover portion provided rotatably about the rotary shaft for opening and closing the opening of the tubular portion,
the rotary shaft and the cover portion being provided on a fixing member fixable to the tip side of the tubular portion passed through the mounting hole.

2. The vehicle connector of claim 1, wherein the fixing member is fittably provided on the tip side of the tubular portion.

3. The vehicle connector of claim 1, wherein the fixing member is detachably provided on the tip side of the tubular portion.

4. The vehicle connector of claim 1, wherein the fixing member is formed into an annular shape externally fittable to the tubular portion.

5. The vehicle connector of claim 1, wherein the fixing member is provided with a locked portion lockable by a locking portion provided on the cover portion in a closing state of the cover portion.

6. The vehicle connector of claim 5, wherein the locked portion is a locking shaft as a common component to the rotary shaft.
